(19) United States
(12) Patent Application Publication
(10) Pub. No.: US 2010/0289388 A1
(43) Pub. Date: Nov. 18, 2010

(54) Drive Device Having an Electric Motor and an Electronic Control System Having a Circuit Carrier

(76) Inventors: Peter Kimmich, Schoenaich (DE); Quoc-Dat Nguyen, Reutlingen (DE); Christoph Ruf, Eningen (DE); Wolfgang Jacob, Horb (DE)

Correspondence Address: KENYON & KENYON LLP, ONE BROADWAY, NEW YORK, NY, 10004, US

(21) Appl. No.: 12/227,302

(22) PCT Filed: May 29, 2007
(86) PCT No.: PCT/EP2007/055166

§ 371 Date: Aug. 9, 2010

(30) Foreign Application Priority Data
Jun. 7, 2006 (DE) 10 2006 026 403.7

(51) Int. Cl. H02K 5/22

(52) U.S. Cl. 310/68 D

(57) ABSTRACT

A drive device having an electric motor and an electronic control system for the electric motor, the electronic control system being disposed on a circuit carrier. Provision is made that the circuit carrier is a mechanical component, or part of a mechanical component, of the electric motor.

### FIELD OF THE INVENTION

The present invention relates to a drive device having an electric motor and an electronic control system for the electric motor, the electronic control system being disposed on a circuit carrier.

### BACKGROUND INFORMATION

A drive device which has an electric motor and a control unit for applying control to the electric motor, is conventional. These two assemblies are present as independent units. The user utilizing the electric motor has the ability to bolt the control unit with its housing onto the housing of the electric motor, and then to make the necessary electrical connections between these two units.

### SUMMARY

In accordance with an example embodiment of the present invention, in which the drive device has an electric motor and an electronic control system for the electric motor, which system is disposed on a circuit carrier, the circuit carrier performs a dual function: on the one hand, the circuit carrier carries the electronic control system, and on the other hand it is a mechanical component, or part of a mechanical component, of the electric motor. The electronic control system is thereby integrated into the electric motor, the circuit carrier additionally assuming the function of a mechanical component, or part of a mechanical component, of the electric motor.

The aforementioned connection of two independent units, by bolting the housings together and the like, can be omitted; in other words, the conventional mechanical and electrical interfaces between the electric motor and electronic control system are eliminated according to the present invention.

According to one embodiment of the present invention, provision is made that the circuit carrier constitutes a housing part of the electric motor. It consequently assumes the function of a housing part and simultaneously the function of carrying the electronic control system, which latter is configured on the circuit carrier.

It may be advantageous if the circuit carrier is the carrier of a bearing for the electric motor. A further function, in particular, is consequently added, in that the circuit carrier serves as a receiver for a bearing of the electric motor.

According to a refinement of the example embodiment of the present invention, provision is made that the circuit carrier is embodied as a bearing plate of the electric motor. The bearing plate consequently carries one of the bearings of the electric motor. The circuit carrier embodied in this fashion can furthermore constitute part of the housing of the electric motor, and furthermore also assumes its basic function, namely receiving the electronic control system.

It may be advantageous if the circuit carrier is embodied as a deep-drawn part. By being configured in this fashion, it can receive, in the manner of a shell, the electronic components of the electronic control system. A deep-drawn bearing flange of the circuit carrier is outstandingly suitable for receiving the aforesaid bearing of the electric motor.

The circuit carrier is preferably made of metal, in particular of aluminum or an aluminum alloy.

It may be additionally advantageous if the circuit carrier has a deep-drawn receptacle for the bearing of the electric motor. Reference to this has been made above. This deep-drawn receptacle can be embodied as a bearing flange.

A development of the example embodiment of the present invention provides that the circuit carrier constitutes a heat sink for the electronic control system. If the carrier is made from a correspondingly thermally conductive material, for example from the aforesaid thermally conductive aluminum or the aforementioned aluminum alloy, heat loads of the electronic control system can thus be transferred to the circuit carrier, and cooling of the electronic system can thereby be effected. It may be particularly advantageous in this context if the circuit carrier is connected in thermally conductive fashion to the electric motor or to corresponding parts of the electric motor. The result of this is that the heat evolved by the electronic control system is transferred to the circuit carrier and from there to the other parts of the electric motor, thus resulting in a very good cooling effect.

Lastly, it may be advantageous if the circuit carrier has associated with it a cover that covers the electronic control system. The cover protects the electronic control system from mechanical as well as other influences.

### BRIEF DESCRIPTION OF THE DRAWINGS

FIG. 1 is a perspective view of an electronic control system configured in/on/onto a circuit carrier, the circuit carrier simultaneously constituting a bearing plate of an electric motor that is electrically controlled by the electronic control system.

FIG. 2 is a schematic lateral section through a region of the electric motor whose bearing plate is constituted by the circuit carrier.

### DETAILED DESCRIPTION OF EXAMPLE EMBODIMENTS

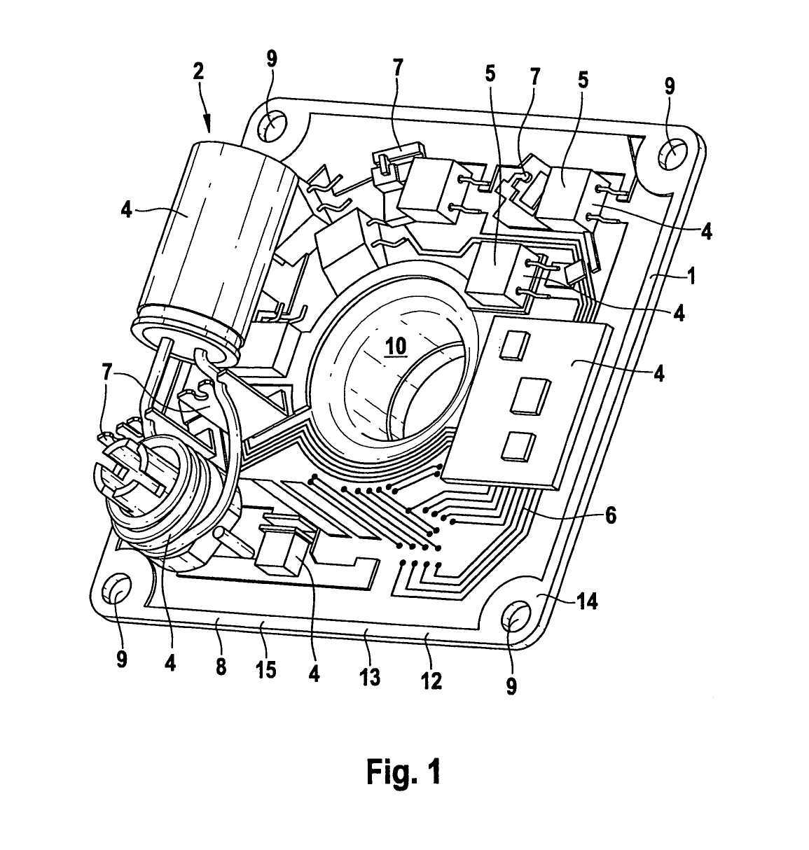

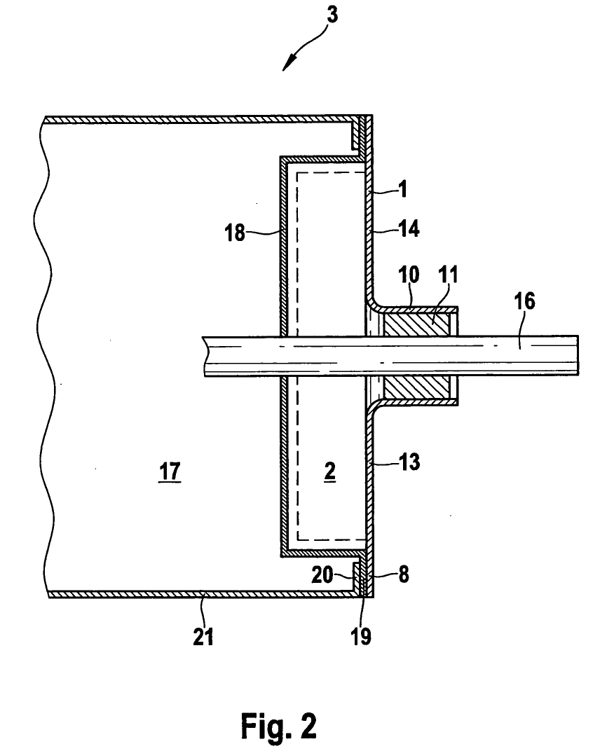

FIG. 1 shows a circuit carrier 1 on which is configured an electronic control system 2 for an electric motor 3 (FIG. 2). Electronic control system 2 is made up of multiple electronic components 4, also including power transistors 5. Electronic control system 2 further encompasses conductor paths 6 and electrical plug devices 7. Electrical plug devices 7 can be connected to corresponding counter-plugs for delivery of a supply voltage, discharge of a control voltage for the electric motor, and also for the delivery of control variables.

Circuit carrier 1 is embodied as a deep-drawn part. It is made of aluminum or an aluminum alloy, and is tub-shaped with a peripheral flange 8. The aforementioned electronic control system 2 is substantially housed in the interior of the tub. Flange 8 has a square cross section and is penetrated by attachment holes 9. Circuit carrier 1 possesses at the center a deep-drawn recess 10 that serves to receive a bearing 11 (FIG. 2) of electric motor 3.

Circuit carrier 1 therefore constitutes a mechanical component 12 of electric motor 3, namely a bearing plate 13 of electric motor 3. Bearing plate 13, and consequently circuit carrier 1, further constitute a housing part 14 of electric motor 3, this being evident in particular from FIG. 2

Some of the electronic constituents 4, in particular the aforesaid power transistors 5, are in thermal contact with circuit carrier 1, so that heat evolved by the electronic control system during operation is transferred to circuit carrier 1 so that the latter constitutes a heat sink 15 for electronic control system 2.

As shown in FIG. 2, electric motor 3 has a shaft 16 that is supported in bearing 11, bearing 11 being held in receptacle 10 of circuit carrier 1. Circuit carrier 1 consequently constitutes the aforementioned bearing plate 13, which also constitutes a part of the housing of electric motor 3. Located in interior 17 of electric motor 3 is electronic control system 2, which is indicated by a dashed line. Electronic control system 2 is encased by a cover 18 that is penetrated by shaft 16 and protects electronic control system 2. Flange 8 of circuit carrier 1 is bolted to a flange 19 of cover 18 and to a flange 20 of housing 21 of electric motor 3. Corresponding screw connections, which are guided through attachment holes 9 and through corresponding holes in flanges 19 and 20, are used for this purpose.

The procedure according to the present invention results in very low thermal resistance for the heat evolved by electronic components 4 of electronic control system 2, since good heat transfer to circuit carrier 1, which is highly conductive in thermal terms, is implemented so that circuit carrier 1 acts as a heat sink 15. Because circuit carrier 1 is furthermore joined in thermally conductive fashion to cover 18 and/or to housing 21, these components also serve for heat dissipation. All the aforesaid components exhibit very low thermal resistance with respect to one another, so that the heat of the power semiconductors, in particular of power transistors 5, and of other components is dissipated very effectively, with the consequence that smaller power semiconductors and/or components can be used. Components and processes can furthermore be eliminated from the overall system as compared with conventional apparatuses, since a separate power substrate is not necessary, a control unit baseplate does not need to be used, and adhesive bonding of the power substrate onto the baseplate can also be omitted. In toto, the electronics and the overall system can be made smaller than was previously the case, and also more economical.

The aforesaid bearing of the electric motor, which can be embodied, e.g., as a ball bearing, can easily and effectively be attached to circuit carrier 1, for example by being pressed in; circuit carrier 1, equipped in that fashion as a bearing plate 13 and housing part 14, is bolted directly onto the electric motor. Electronic control system 2 can additionally be covered by the aforementioned cover 18.

The present invention is usable in particular in the context of electric motors in the vehicle sector, for example electric motors having an electronic control system that serve to operate the vehicle's power steering system.

1-10. (canceled)

11. A drive device, comprising:
an electric motor, and
an electronic control system for the electric motor, the electronic control system being disposed on a circuit carrier, the circuit carrier being a mechanical component or part of a mechanical component of the electric motor.

12. The drive device as recited in claim 11, wherein the circuit carrier is a housing part of the electric motor.

13. The drive device as recited in claim 11, wherein the circuit carrier is a carrier of a bearing for the electric motor.

14. The drive device as recited in claim 11, wherein the circuit carrier is a bearing plate of the electric motor.

15. The drive device as recited in claim 11, wherein the circuit carrier is a deep-drawn part.

16. The drive device as recited in claim 11, wherein the circuit carrier is made of metal.

17. The drive device as recited in claim 16, wherein the metal is aluminum or an aluminum alloy.

18. The drive device as recited in claim 11, wherein a bearing plate is pressed, riveted, welded, adhesively bonded, or bolted into the circuit carrier.

19. The drive device as recited in claim 11, wherein the circuit carrier is a heat sink for the electronic control system.

20. The drive device as recited in claim 11, wherein the circuit carrier is connected in thermally conductive fashion to the electric motor.

21. The drive device as recited in claim 11, wherein the circuit carrier has associated with it a cover that covers the electronic control system.
